(19) United States
(12) Patent Application Publication
(10) Pub. No.: US 2005/0004829 A1
(43) Pub. Date: Jan. 6, 2005

(54) System and method for recording and distributing recordings of live performances on site

(76) Inventor: Gayor Geller, Denver, CO (US)

Correspondence Address: SHERIDAN ROSS PC, 1560 BROADWAY, SUITE 1200, DENVER, CO, 80202, US

(21) Appl. No.: 10/877,248

(22) Filed: Jun. 25, 2004

Related U.S. Application Data
(60) Provisional application No. 60/485,014, filed on Jul. 2, 2003.

(51) Int. Cl. G06F 17/60

(52) U.S. Cl. 705/9; 705/1

(57) ABSTRACT

A method and system for recording live performances entails the pre-purchase of recorded CDs and/or communications to offsite computers of recorded music substantially simultaneously with or shortly after the performance of a live performance. A method of doing business involving the collection of monies prior to the live performance, with such payment to include the later provision of a recorded tangible copy of a live performance, permits the generation of increased revenues to a venue, as well as to musicians performing at such venue. Desired recording signatures on particular recordings (e.g., CDs and/or MP3 communications) are afforded by providing the ability of patrons to record their own voice, announcement of special occasions, and/or musical contributions as part of the recorded CD, thus enhancing the live performance experience as well as documenting the same for future listening enjoyment.

### RELATED APPLICATION

This application claims priority from U.S. Provisional Patent Application No. 60/485,014 filed on Jul. 2, 2003. The entire disclosure of the provisional application is considered to be part of the disclosure of the accompanying application and is hereby incorporated by reference.

### FIELD OF THE INVENTION

The present invention is directed to a system and method that facilitates on site recordings of live performances and the substantially immediate duplication of such recordings for onsite distribution, as well as a method of doing business with respect to the promotion of live performances and recordings thereof.

### BACKGROUND AND SUMMARY OF THE PRESENT INVENTION

Traditionally, music CDs are recorded either in a studio or at a live performance and a master recording thereof is then utilized to mass produce audio recordings for distribution to the public, either in the form of tapes, CDs, MP3 transmissions, etc. Such master tape recordings often include particular mixing, editing, signal processing, etc. to optimize certain aspects of the recording to achieve desired quality. The typical production of CD's entails a process that can take months and thousands of dollars, and as such, is not practical for producing limited numbers of recordings of a performance or for producing recordings substantially at the time of a live performance. The advantages of the present invention over the prior art includes alleviating some of the “bootlegging” activities that severely impact the financial returns to performing artists. Moreover, the present invention permits increased revenues to artists through the sale of CD's or and/or MP3 recordings at a live performance, with the cost of such CD, etc. being encompassed within the “cover charge” for attendees of a large performance. As such, the musicians achieve not only greater compensation at the time they perform, they also achieve greater advertising recognition by providing interested consumers with actual copies of their music at the venue where the customer is present.

To facilitate a better understanding of the present invention, the inventors incorporate by reference in its entirety U.S. Patent Application Publication 20020051407 to Griner entitled “System and Method of Creating Digital Recordings of Live Performances.” Many of the difficulties encountered in the music industry are discussed in the above-referenced patent publication and the system and methods described therein can find application in the present system and method described and claimed herein.

The present invention is distinct from that described by Griner in several respects. For example, Griner's system appears to be a far more complicated and expensive endeavor, requiring more equipment and the presence of several technicians. Moreover Griner does not produce an actual physical MASTER CD at the live performance, but instead Griner breaks down the performance to segments. Each segment (track) is then edited separately in an editing module. Griner refers to each edited track as a “master audio file”. Each master audio file is forwarded to a ‘secondary digital recording device’, and from the secondary digital recording device each ‘numbered mastered track file’ is “made available to media recordings” (See, Griner, pg 8). From the secondary digital recording device each file is then forwarded to computers that serve as recording controllers. Each one of these recording controls has a series of recorders that write the tracks on CDs. Each ‘mastered track’ is written separately on each CD. Griner system is cumbersome and complex by comparison to the present invention and appears to be a modification on a typical studio recording system. As such, the Griner system is likely to take a longer time and to be more complex, it is not—user friendly, and is more expensive to set up and use as compared to the present invention.

In one embodiment of the present invention, the entire edited part of the performance that is to be released on a distributed CD is forwarded to a Master CD Burner and a physical Master CD is produced. This master CD is inserted in a Tower Duplicator and the CDs that are produced for distribution are labeled and distributed in conjunction with various business models of distribution and revenue generation methods as described herein. Attached hereto as Exhibit A is further information concerning the recording of live performances and the distribution of CDs with respect thereto, all of which is incorporated herein by reference.

In one embodiment to the present invention, a sound board is provided that is capable of receiving all stage sound input from “snake” inputs positioned on the stage. All stage sound is thereby “collected” and is conveyed to the sound board at the facility where a live performance is being held. The sound board conveys signals with appropriate sound mixes to speakers (for the audience to hear) and to a pre-mastering mixing device. The pre-mastering mixing device receives sound input from the sound board either through specific channels or through distinct locations of the venue. Separate channels can be provided and manipulated to achieve desired sound effects from particular signals, or through one particular channel that is provided for the entire venue. Appropriate microphones (either mono or stereo in nature) can be positioned at desired locations throughout a particular venue in order to record live and authentic “crowd sounds”. Such crowd sounds can be emerged together with the signal of the live music performance, with such mixing being performed at the sound board location. In one embodiment, each microphone input is adapted so that it can receive its own channel on the pre-mastering mixing device in order that such signal can be manipulated to achieve a desired result.

The pre-mastering mixing device is operatively connected to at least one master CD burner. Signals are conveyed from the pre-mastering mixing device to at least one master CD burner such that desired sound mix is conveyed. The input level of transmission from the pre-mastering mixing device is appropriately adjusted on the master CD burners to allow for a substantially constant level of sound recording. In other embodiments, the master CD burners are adjusted to permit the tracking of individual recordings and the appropriate assignment of time/space on mastering recordings.

After a predetermined recording period is completed, a master CD is finalized by the master CD burners and the resulting master CD can then be inserted into a master tray on a multiple tower burning device. Suitable recordable CDs or CDRs are then inserted into the duplicating drives of the multiple tower burning devices to accomplish duplication at chosen and desired speeds. Such a duplication process is repeated as many times as desired. A completed series of duplicated CDs or CDRs are then appropriately labeled, preferably with the date of the performance, identification of the musicians, songs, venue, etc. It is also possible to provide on the recording CDs a limited edition series. Moreover, one particular aspect of the present invention permits personalized messages and/or “sound autographs” or signatures” to be added to any particular recording for any particular customer and/or venue and/or occasion. In such a way, individuals who attend a particular performance can have, for example, their own voice recorded on the CD, a brief interview with the performing artist, Happy Birthday Sentiments expressed, etc. to add to the personalized character of the CD.

In accordance with the present invention, performing bands achieve a long felt and unsolved need to have their performances recorded substantially simultaneously with their performance and further distributed to the fans of such musicians at the time of the performance. Particular venues may achieve a fair degree of recognition with respect to such recordings given that venues may be known for particularly high quality recordings of bands in a small venue setting such that the venue itself will achieve some reknown in this regard.

In one particular aspect of the present invention, it is possible to customize particular recordings to coincide with the desires of any particular patron. For example, a patron may wish to have a recording of a live performance with only particular songs included thereon. (e.g., without a long drum solo, etc.). Moreover, a particular patron may prefer to have a recorded CD having particular songs recorded at the live performance venue interspersed with an interview with one or more of the band members, other patrons, announcements of special occasions (e.g., birthdays, anniversaries, class reunions, special charitable events, etc.). The present invention includes the ability of a particular patron to select the content of the recorded CD to further enhance the later listening pleasure of such patron. Additional charges for such “customized” services can be received by the venue and/or by the individual/entities producing the recordings at such venue.

A separate aspect of the present invention permits third party advertisers, sponsors, etc. to include particular messages at the time of the recording, thus permitting a separate steam of advertising revenues to be achieved by the musicians, venue, etc., as desired.

In accordance with a method of doing business directed to the present invention, venues can charge particular ticket prices that include the purchase of a recorded live performance CD (or other suitable communication of a recording. Thus, not only does the venue achieve a higher ticket price (i.e., cover charge) for each patron, the patron walks away with a “souvenir” from the experience, further enhancing the prolonged listening enjoyment of patrons, adding to the prospect of increased further patronage at such venue, enhancing the reputation and distribution of the particular musicians work product, etc. A further aspect of the present method permits patrons who may not wish to pay a higher price of a cover charge (which includes a purchase of a recorded CD) to still attend the live performance, with the prospect that CDs of the live performance will be made available at some point during and/or after the live performance (while still on the premises) for a particular price (e.g., slighter higher than the price that's charged if a pre-purchase at the time of entrance was achieved).

Still others aspects of the present invention include the distribution of recorded CDs and/or communication of recorded music through computer connections (MP3, etc.,) when individuals who request the same at the title of a performance. For example, patrons may provide their Internet addresses so that particular songs and/or the entire recording can be communicated directly to them at an appropriate time in the future, and/or simultaneously through their computers while the patrons are onsite at the venue with live performances being performed.

Other aspects of the present invention will be clear to one of ordinary skill in the art by review of the present application as well as the diagram appended hereto as FIG. 1.

While various embodiments of the present invention have been described in detail, it is apparent that further modifications and adaptations of the invention will occur to those skilled in the art. However, it is to be expressly understood that such modifications and adaptations are within the spirit and scope of the present invention.

### BRIEF DESCRIPTION OF THE DRAWINGS

FIG. 1 illustrates a flowchart depicting one aspect of the present invention.

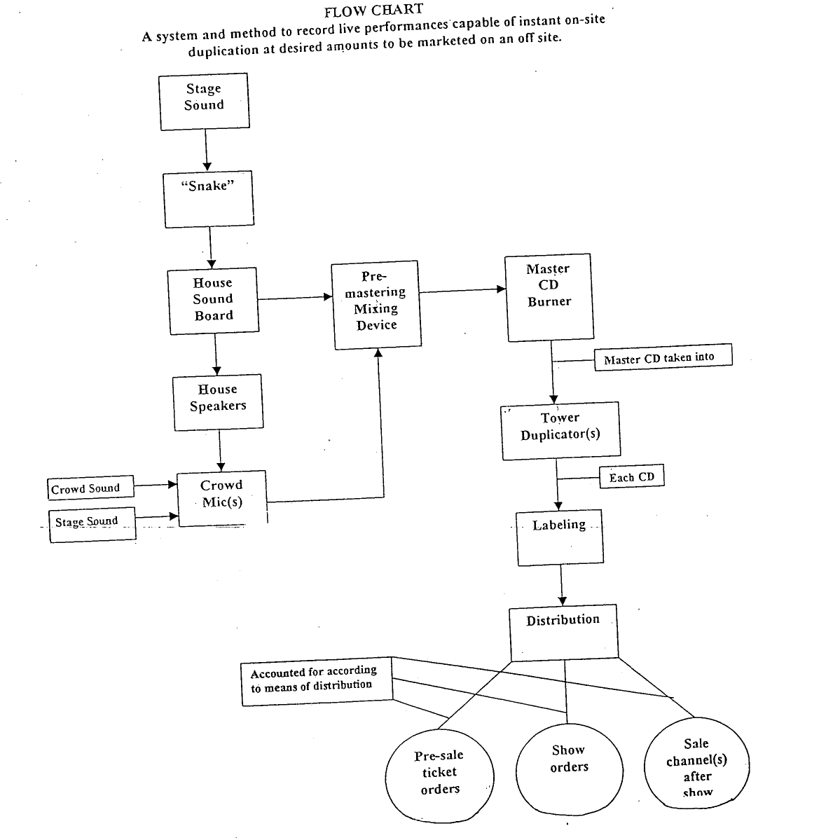

1. A method of conducting a music distribution business, comprising:
providing sound recording equipment at a particular venue such that a significant number of copies of a desired recording may be produced at such venue and can be either recorded onto a compact disc and/or communicated directly to designated off-site computers via the Internet;
providing a distinctive recording signature on said recordings, said distinctive signature selected from the group consisting of a recording of a particular purchaser's voice and/or musical performance, the voice of a musician performing at said venue or the announcement of a special occasion;
charging a fee for customers at the time the customers enter said venue to attend a live performance with said fee including a charge for CD recorded at said venue; and
providing a tangible copy of a recording to a plurality of customers that paid said entrance fee prior to the time said customer leaves the venue premises.
